(19) United States
(12) Patent Application Publication
(10) Pub. No.: US 2026/0289997 A1
(43) Pub. Date: Sep. 24, 2026

(54) SYSTEMS AND METHODS FOR MACHINE LEARNING MODEL SELECTION AND USE FOR IMAGE PROCESSING

(71) Applicant: QUALCOMM Incorporated, San Diego, CA (US)

(72) Inventors: Nan ZHANG, Beijing (CN); Jianying DUAN, Beijing (CN); Qi ZENG, Shenzhen (CN)

(21) Appl. No.: 19/478,215

(22) PCT Filed: Jun. 29, 2023
(86) PCT No.: PCT/CN2023/103705

§ 371 Date: Oct. 23, 2025

(51) Int. Cl. G06V 10/70; G06T 3/4023; G06T 3/4046; G06T 3/4053; G06T 7/70; G06V 10/26; G06V 10/764; G06V 10/82; G06V 10/96

(52) U.S. Cl. CPC G06V 10/87; G06T 3/4023; G06T 3/4046; G06T 3/4053; G06T 7/70; G06V 10/26; G06V 10/764; G06V 10/96; G06T 2207/10016; G06T 2207/20021; G06T 2207/20081; G06T 2207/20084; G06V 10/82

(57) ABSTRACT

Imaging systems and techniques are described. A system receives an image. The system selects a trained machine learning model from a plurality of trained machine learning models based on an image resolution of the image and a plurality of input resolutions of the plurality of trained machine learning models. The system processes the image using the trained machine learning model to generate processed image data.

### FIELD

The present disclosure generally relates to image processing. For example, aspects of the present disclosure relate to systems and techniques for splitting up image processing operations for an image between a first device and a second device to reduce power usage and/or heat generation at the first device, with different image processing schemes selected for different scenarios and providing different breakdowns of which device performs which image processing operations.

### BACKGROUND

Many devices include one or more cameras. For example, a smartphone or tablet includes a front facing camera to capture selfie images and a rear facing camera to capture an image of a scene (such as a landscape or other scenes of interest to a device user). A camera can capture images using an image sensor of the camera, which can include an array of photodetectors. Some devices can analyze image data captured by an image sensor to detect an object within the image data. Sometimes, cameras can be used to capture images of scenes that include one or more people.

### BRIEF SUMMARY

Systems and techniques for imaging are described. A system receives an image. The system selects a trained machine learning model from a plurality of trained machine learning models based on an image resolution of the image and a plurality of input resolutions of the plurality of trained machine learning models. The system processes the image using the trained machine learning model to generate processed image data.

According to at least one example, an apparatus for imaging is provided. The apparatus includes a memory and at least one processor (e.g., implemented in circuitry) coupled to the memory. The at least one processor is configured to and can: receive an image; select a trained machine learning model from a plurality of trained machine learning models based on an image resolution of the image and a plurality of input resolutions of the plurality of trained machine learning models; and process the image using the trained machine learning model to generate processed image data.

In another example, a method of imaging is provided. The method includes: receiving an image; selecting a trained machine learning model from a plurality of trained machine learning models based on an image resolution of the image and a plurality of input resolutions of the plurality of trained machine learning models; and processing the image using the trained machine learning model to generate processed image data. %

In another example, a non-transitory computer-readable medium is provided that has stored thereon instructions that, when executed by one or more processors, cause the one or more processors to: receive an image; select a trained machine learning model from a plurality of trained machine learning models based on an image resolution of the image and a plurality of input resolutions of the plurality of trained machine learning models; and process the image using the trained machine learning model to generate processed image data.

In another example, an apparatus for imaging is provided. The apparatus includes: means for receiving an image; means for selecting a trained machine learning model from a plurality of trained machine learning models based on an image resolution of the image and a plurality of input resolutions of the plurality of trained machine learning models; and means for processing the image using the trained machine learning model to generate processed image data.

In some aspects, selecting the trained machine learning model includes selecting, from the plurality of input resolutions, an input resolution that most closely matches the image resolution, wherein the input resolution is associated with the trained machine learning model. In some aspects, selecting the trained machine learning model includes selecting, from the plurality of input resolutions, an input resolution that is closest to the image resolution while being larger than the image resolution, wherein the input resolution is associated with the trained machine learning model.

In some aspects, selecting the trained machine learning model includes: selecting, from a plurality of estimated processing times corresponding to the plurality of trained machine learning models, at least one estimated processing time that fits within a time limit, wherein the plurality of estimated processing times indicate how long the plurality of trained machine learning models are estimated to take to process image data; and selecting, from the plurality of input resolutions, an input resolution that is a highest resolution and that also corresponds to a first estimated processing time of the at least one estimated processing time that fits within the time limit, wherein the input resolution is associated with the trained machine learning model, and wherein the trained machine learning model is estimated to use the first estimated processing time to process the image. In some aspects, the time limit is associated with a frame rate of a video, wherein the image is a video frame of the video.

In some aspects, one or more of the methods, apparatuses, and computer-readable medium described above further comprise: segmenting a secondary image into a plurality of tiles, wherein the image is a tile of the plurality of tiles, and wherein the processed image data includes a processed variant of the tile. In some aspects, one or more of the methods, apparatuses, and computer-readable medium described above further comprise: combining the processed variant of the tile with at least one processed variant of at least one additional tile of the plurality of tiles to generate a processed variant of the secondary image.

In some aspects, receiving the image includes scaling a secondary image to generate the image, wherein the secondary image has a secondary image resolution that is different from the image resolution of the image. In some aspects, the image resolution is closer to an input resolution of the trained machine learning model than the secondary image resolution.

In some aspects, receiving the image includes adding padding pixels to at least one side of a secondary image to generate the image, wherein the secondary image has a secondary image resolution that is smaller than the image resolution of the image. In some aspects, the image resolution is closer to an input resolution of the trained machine learning model than the secondary image resolution.

In some aspects, processing the image includes performing super-resolution on the image using the trained machine learning model to generate the processed image data, wherein the processed image data has a higher resolution than the image resolution of the image. In some aspects, processing the image includes detecting an object in the image using the trained machine learning model to generate the processed image data, wherein the processed image data indicates a position of the object within the image. In some aspects, processing the image includes segmenting the image into pixels belonging to different object categories using the trained machine learning model to generate the processed image data, wherein the processed image data indicates which pixels of the image belong to which of the different object categories.

In some aspects, one or more of the methods, apparatuses, and computer-readable medium described above further comprise: outputting the processed image data. In some aspects, one or more of the apparatuses and computer-readable medium described above further comprise: a display configured to display the processed image data. In some aspects, one or more of the apparatuses and computer-readable medium described above further comprise: a communication interface configured to transmit the processed image data to a recipient device.

In some aspects, the trained machine learning model is a convolutional neural network (CNN).

In some aspects, the apparatus is part of, and/or includes a wearable device, an extended reality device (e.g., a virtual reality (VR) device, an augmented reality (AR) device, or a mixed reality (MR) device), a head-mounted display (HMD) device, a wireless communication device, a mobile device (e.g., a mobile telephone and/or mobile handset and/or so-called “smart phone” or other mobile device), a camera, a personal computer, a laptop computer, a server computer, a vehicle or a computing device or component of a vehicle, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 is a block diagram illustrating an example architecture of an image capture and processing system, in accordance with some examples;

FIG. 2 is a block diagram illustrating an architecture of an imaging system that selects an image processing scheme for processing an image to generate processed image data, in accordance with some examples;

FIG. 3A is a perspective diagram illustrating a head-mounted display (HMD) that is used as part of an imaging system, in accordance with some examples;

FIG. 3B is a perspective diagram illustrating the head-mounted display (HMD) of FIG. 3A being worn by a user, in accordance with some examples;

FIG. 4A is a perspective diagram illustrating a front surface of a mobile handset that includes front-facing cameras and that can be used as part of an imaging system, in accordance with some examples;

FIG. 4B is a perspective diagram illustrating a rear surface of a mobile handset that includes rear-facing cameras and that can be used as part of an imaging system, in accordance with some examples;

FIG. 5 is a perspective diagram illustrating a vehicle that includes various sensors, in accordance with some examples;

FIG. 6 is a block diagram illustrating an example of a neural network that can be used for imaging, in accordance with some examples;

FIG. 7 is a flow diagram illustrating a process for image processing, in accordance with some examples; and

FIG. 8 is a diagram illustrating an example of a computing system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Imaging systems and techniques are described. In some examples, a system monitors a characteristic of power usage of the apparatus. The system selects, based on at least the characteristic of power usage of the apparatus, an imaging scheme from a plurality of imaging schemes. Each of the plurality of imaging schemes represents a different division of image processing operations between the at least one processor and a companion device. The system sends image data to the companion device for processing the image data using at least one image processing operation to generate processed image data according to the imaging scheme. The system receives the processed image data from the companion device.

The imaging and feature tracking systems and techniques described herein provide a number of technical improvements over prior imaging and feature tracking systems. For instance, the imaging and feature tracking systems and techniques described herein can reduce power usage and heat generation by a headset or other device by offloading certain image processing operations onto another device (a host device) that is less battery-constrained and/or temperature-constrained. For instance, headsets are generally built to be even smaller and lighter than handsets because headsets are built to be worn on a user's face and/or head for long periods of time, and need to be comfortable to users wearing them in this manner. Because of this, headsets have even less capacity (both in terms of physical space and weight) for large batteries than handsets, and instead generally have smaller batteries than handsets. Furthermore, because headsets are built to be worn on a user's face and/or head for long periods of time, headsets are even more temperature-sensitive than handsets, as a user's face and eyes are generally even more sensitive to heat (and/or damage from high heat) than a user's hands or pockets. By pushing certain image processing operations described as performed by the imaging system from the headset to the handset as discussed with respect to some of the image processing schemes discussed herein, the headset is able to use less battery power, last longer, maintain a lower (and thus safer) heat by generating less heat, and require less thermal dissipation hardware (e.g., fans or other cooling systems) or thermal throttling (e.g., which can result in undesirable performance drops) as a result.

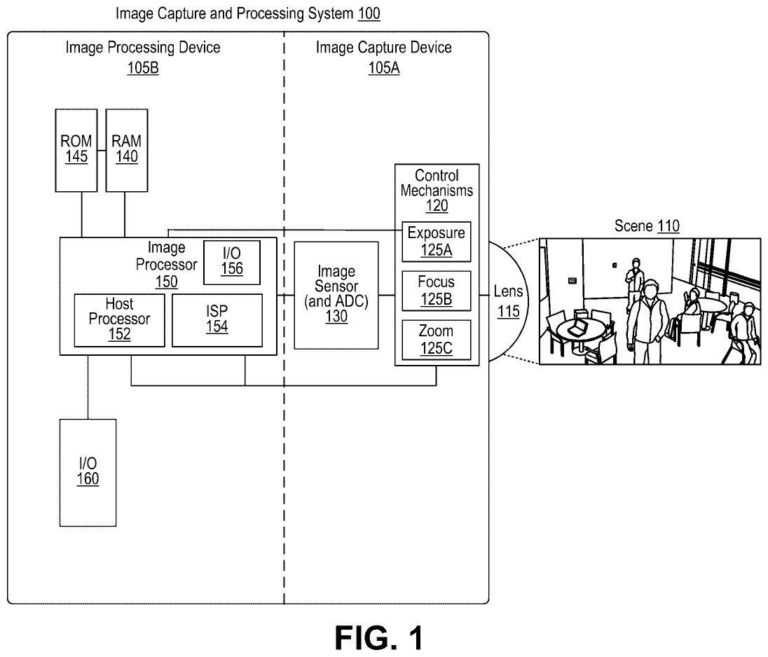

Various aspects of the application will be described with respect to the figures. FIG. 1 is a block diagram illustrating an architecture of an image capture and processing system 100. The image capture and processing system 100 includes various components that are used to capture and process images of one or more scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130. In some examples, the scene 110 is a scene in an environment. In some examples, the image capture and processing system 100 is coupled to, and/or part of, a vehicle 190, and the scene 110 is a scene in an environment around the vehicle 190. In some examples, the scene 110 is a scene of at least a portion of a user. For instance, the scene 110 can be a scene of one or both of the user's eyes, and/or at least a portion of the user's face.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting. In some examples, an exposure setting can be provided to the exposure control mechanism 125A of the control mechanisms 120 from the image processor 150, the host processor 152, the ISP 154, or a combination thereof.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 810 discussed with respect to the computing system 800. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140 and/or 820, read-only memory (ROM) 145 and/or 825, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 835, any other input devices 845, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the system 100 and one or more peripheral devices, over which the system 100 may receive data from the one or more peripheral device and/or transmit data to the one or more peripheral devices. The I/O 160 may include one or more wireless transceivers that enable a wireless connection between the system 100 and one or more peripheral devices, over which the system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

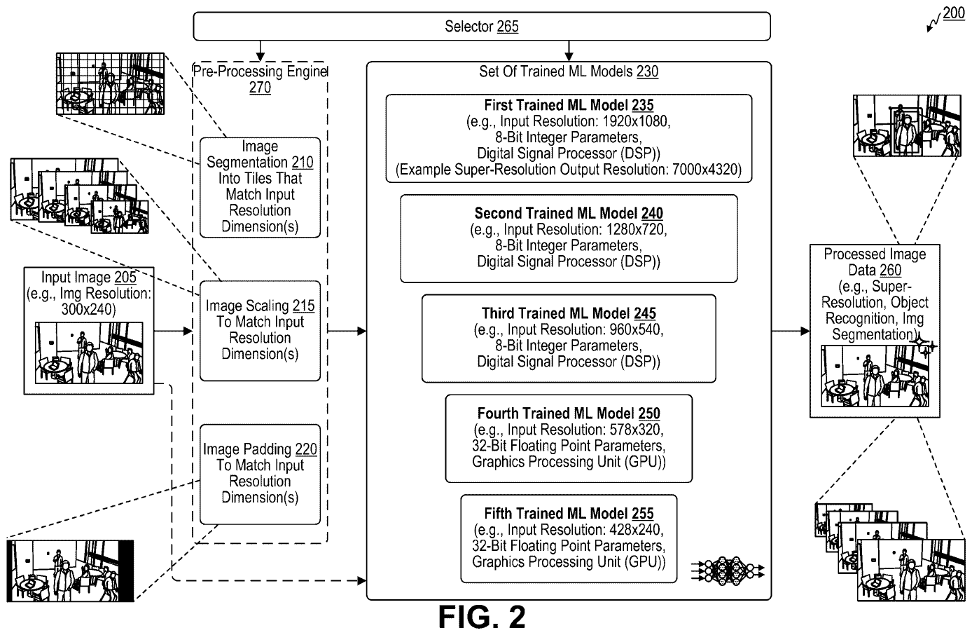

FIG. 2 is a block diagram illustrating an architecture of an imaging system 200 that selects an image processing scheme for processing an input image 205 to generate processed image data 260. The imaging system 200 includes a selector 265 and a set of trained machine learning (ML) models 230. The imaging system 200 uses the selector 265 to select one trained ML model of the set of trained ML models 230 to use to process the input image 205 to generate the processed image data 260. The selected trained ML model can process the input image 205 in a variety of ways, and thus, the processed image data 260 can include a variety of types of data. In FIG. 2, a box representing the input image 205 includes an illustration of an image of the scene 110. In FIG. 2, a box representing the processed image data 260 includes an illustration of an image of the scene 110 with a sparkle icon in the upper-right corner, representing the input image 205 having been processed (using the selected trained ML model of the set of trained ML models 230) to generate the processed image data 260.

In some examples, the selected trained ML model can process the input image 205 using an image processing technique (e.g., image enhancement), and the processed image data 260 thus includes a variant of the input image 205 that is processed (e.g., enhanced) using the image processing technique (e.g., image enhancement). For instance. in some examples, the selected trained ML model can process the input image 205 using super-resolution, and the processed image data 260 thus includes a variant of the input image 205 that is larger and/or that has a higher resolution than the input image 205. In FIG. 2, below the box representing the processed image data 260 (and extending from the box using dashed lines), is a graphic representing super-resolution, with a representation of the input image 205 of the scene 110 increasing in size from left to right. In some examples, image processing and/or image enhancement can also include deblurring, distortion correction or compensation, denoising, sharpening, rolling shutter correction or compensation, brightening, dimming, overexposure correction or compensation, underexposure correction or compensation, stabilization, temporal denoising, spatial denoising, filtering, machine learning based denoising, machine learning based sharpening, color changes, contrast changes, saturation changes, tone mapping, white balance changes, black balance changes, other image processing operations discussed herein, or combinations thereof.

In some examples, the selected trained ML model can process the input image 205 using feature detection, feature recognition, object detection, object recognition, facial detection, facial recognition, person detection, person recognition, vehicle detection, vehicle recognition, character detection, character recognition, animal detection, animal recognition, material detection, material recognition, classification, semantic segmentation, and/or segmentation. In such examples, the processed image data 260 thus includes data that identifies where, in the input image 205, one or more instances of a given element (e.g., feature, object, face, person, vehicle, character, animal, material, etc.) are detected, recognized, and/or depicted. In element recognition (e.g., feature recognition, object recognition, face recognition, person recognition, vehicle recognition, character recognition, animal recognition, material recognition, etc.), the processed image data 260 can recognize that the particular instance of the detected element (e.g., feature, object, face, person, vehicle, character, animal, material, etc.) matches a known instance of the element (e.g., previously depicted in an earlier video frame if the input image 205 is a video frame, and/or matching a previously-stored dataset of image(s) depicting the element and/or other element(s)). Using the selected trained ML model to apply image classification, semantic segmentation, and/or other forms of segmentation to the input image 205 can work similarly, for instance with the processed image data 260 including classifications for different pixels of the input image 205 (e.g., identifying which pixels depict skin, which pixels depict hair, which pixels depict sky, which pixels depict plants, which pixels depict stone, which pixels depict metal, which pixels depict wood, which pixels depict food, which pixels depict vehicles, which pixels depict animals, which pixels depict other materials or object types, etc.). In FIG. 2, above the box representing the processed image data 260 (and extending from the box using dashed lines), is a graphic representing object recognition, with a representation of a bounding box over a person in the scene 110 overlaid over a representation of the input image 205 of the scene 110. The bounding box represents, for instance, person detection, person recognition, object detection, object recognition, classification, semantic segmentation, segmentation, or a combination thereof.

The set of trained ML models 230 may be pre-quantized, pre-compiled, pre-configured, and/or trained to match a hardware digital signal processor (DSP) and/or graphics processor unit (GPU). In some examples, trained ML model(s) of the set of trained ML models 230 may be quantized to specific fixed input layer resolution(s). The set of trained ML models 230 includes several different trained ML models that vary at least in that they accept different input resolutions (e.g., higher and lower input resolutions) and/or use different quantization schemes (e.g., integers vs. floating point, and/or digital signal processor (DSP) vs. graphics processor unit (GPU)). Input resolution can refer to the resolution of image data that a given trained ML model accepts as an input and is configured to process. In some examples, a specific trained ML model is configured to process image data having a specific input resolution. Generally, trained ML models that are configured for larger input resolutions take more time and computational resources for an image processing task than trained ML models that are configured for larger input resolutions take for the same task. Thus, to reduce time and computational resources used in processing, it is generally optimal to use the trained ML model with the smallest input resolution that works for the input image 205 and a particular use case. On the other hand, a larger input resolution allows the selected trained ML model to process an input image 205 that is larger and/or has a higher resolution, and therefore allows the selected trained ML model to process an input image 205 with more precision and detail than a different trained ML model that has a smaller input resolution.

The different quantization schemes can refer to whether a given trained ML model processes image data using integers (e.g., 8 bits per integer) or floating point numbers (e.g., 32 bits per floating point number), and/or which device is processing the input image 205 using (e.g., digital signal processor (DSP) or graphics processor unit (GPU)). In some examples, the GPU may be more optimized for processing floating point numbers, and can thus be used with floating point numbers. In some examples, the DSP may be more optimized for processing integers, and can thus be used with integers. In some examples, floating point numbers can offer more precision and/or detail in image processing, but can use more time and computational resources in image processing. On the other hand, integers can offer less precision and/or detail in image processing, but can use less time and computational resources in image processing.

For instance, in some examples, the set of trained ML models 230 includes a first trained ML model 235 with a very high input resolution (e.g., 1920 pixels by 1080 pixels), a second trained ML model 240 with a high input resolution (e.g., 1280 pixels by 720 pixels), a third trained ML model 245 with a medium input resolution (e.g., 960 pixels by 540 pixels), a fourth trained ML model 250 with a low input resolution (e.g., 578 pixels by 320 pixels), and a fifth trained ML model 255 with a very low input resolution (e.g., 428 pixels by 240 pixels). Each trained ML model in the set of trained ML models 230 is represented by a box having a width based on its input resolution relative to the other ML models in the set of trained ML models 230, with the first trained ML model 235 represented by the widest box and the fifth trained ML model 255 represented by the narrowest box, respectively. In this way the set of trained ML models 230 is represented as an inverse pyramid shape. In some examples, the width of the boxes representing the different trained ML models in the set of trained ML models 230 also represents the amount of time and/or computational resources used by that trained ML model relative to the other trained ML models in the set of trained ML models 230. For instance, the first trained ML model 235 can use the most time and/or computational resources based on having the highest input resolution, while the fifth trained ML model 255 can use the least time and/or computational resources based on having the lowest input resolution. In an illustrative example where the first trained ML model 235 is used for super-resolution, an example output resolution is 7000 pixels by 4320 pixels.

The selector 265 can select a trained ML model (from the set of trained ML Models 230) based on attribute(s) of the input image 205. In some examples, the selector 265 can select the trained ML model (from the set of trained ML Models 230) based on the resolution, size, and/or dimensions of the input image 205. In some examples, the resolution, size, and/or dimensions of the input image 205 exactly matches the input resolution of a specific trained ML model of the set of trained ML Models 230. In such a case, the selector 265 can select that specific trained ML model that has the matching input resolution that matches the resolution of the input image 205. For instance, if the resolution, size, and/or dimensions of the input image 205 are 1280 pixels by 720 pixels, the selector 265 can select the second trained ML model 240, which has an input resolution of 1280 pixels by 720 pixels.

In some examples, the imaging system 200 includes a pre-processing engine 270 that can perform pre-processing of the input image 205 to generate intermediate image data. The intermediate image data is then input into the selected trained ML model (of the set of trained ML models 230) to be processed to generate the processed image data 260. The pre-processing engine 270 can process the input image 205 using at least one of several pre-processing techniques. In some examples, the selector 265 can also select one or more of the pre-processing techniques, for instance based on at least one attribute of the input image 205 and/or a selection by the selector 265 of the trained ML model (of the set of trained ML models 230).

In some examples, the pre-processing engine 270 can process the input image 205 using image segmentation 210, which is a pre-processing technique that splits (or segments, or divides, or partitions) the input image 205 into tiles that are then individually processed using the selected trained ML model (of the set of trained ML models 230) and recombined after processing. This can be useful if the input image 205 is very large or has a high resolution, such as a 2K image (2560 pixels×1440 pixels) or 4K image (3,840 pixels×2,160 vertical pixels), which can then be split into smaller tiles (e.g., tiles of resolution 960 pixels by 540 pixels, matching the third trained ML model 245) for processing. In this way, the selected trained ML model (e.g., the third trained ML model 245) can individually process each tile, and the tiles can be recombined into the processed image data 260. In FIG. 2, a graphic illustrates image segmentation 210 by dividing an instance of input image 205 of the scene 110 into square tiles using black lines. In some examples, the tiles are square, while in other examples, the tiles may be rectangular (e.g., oblong rectangles having one dimension longer than the other).

In some examples, the pre-processing engine 270 can process the input image 205 using image scaling 215, which is a pre-processing technique that resizes or rescales (e.g., downscales or upscales) the input image 205 to generate an intermediate image to be input to the selected trained ML model (of the set of trained ML models 230) for processing. For instance, in some examples, the selector 265 can select the trained ML model (of the set of trained ML models 230) that has an input resolution that is closest to the resolution of the input image 205. The pre-processing engine 270 can then use image scaling 215 to resize or rescale the input image 205 into an intermediate image, which is then input into the selected trained ML model (of the set of trained ML models 230). The selected trained ML model processes the intermediate image to generate the processed image data 260. Because trained ML models having larger input resolutions are generally take more time and computational resources, and upscaling (resizing to a larger size) generally does not improve image quality, the selector 265 can select the trained ML model (of the set of trained ML models 230) that has the largest input resolution that is less than or equal to the image resolution of the input image 205, to avoid upscaling (and instead to only downscale). In an illustrative example, if the input image 205 has an image resolution of 1600 pixels by 900 pixels, the pre-processing engine 270 can process the input image 205 using image scaling 215 downscale the input image 205 by a factor of 80% to generate an intermediate image having a resolution of 1280 pixels by 720 pixels, which matches the input resolution of the second trained ML model 240. In FIG. 2, a graphic illustrates image scaling 215 by showing an instance of the input image 205 of the scene 110 being downsized to a smaller size from left to right in the graphic.

In some examples, the pre-processing engine 270 can process the input image 205 using image padding 220, which is a pre-processing technique that adds padding pixels to at least one side of the input image 205 to generate an intermediate image that includes padding added onto at least one side of the input image 205. The padding pixels can include white pixels, black pixels, transparent pixels (e.g., indicated as transparent using an alpha channel), pixels that draw a pattern (e.g., a checkerboard pattern), or a combination thereof. In some examples, the selector 265 can select the trained ML model (of the set of trained ML models 230) that has the smallest input resolution that is greater than or equal to the image resolution of the input image 205, with any gap between the image resolution of the input image 205 and the input resolution of the selected trained ML model filled in with padding pixels. In an illustrative example, if the input image 205 has an image resolution of 1080 pixels by 720 pixels, the pre-processing engine 270 can process the input image 205 using image padding 220 to add 200 pixels of padding to extend the side of the input image 205 from 1080 pixels to 1280 pixels to generate an intermediate image having a resolution of 1280 pixels by 720 pixels, which matches the input resolution of the second trained ML model 240. In FIG. 2, a graphic illustrates image padding 220 by showing an instance of the input image 205 of the scene 110 with black padding pixels added to the left and right sides.

In some examples, the pre-processing engine 270 can process the input image 205 using a combination of image segmentation 210, image scaling 215, and image padding 220. For instance, if the input image 205 has a resolution of 1188 pixels by 792 pixels, the pre-processing engine 270 can process the input image 205 using image scaling 215 to downscale the input image 205 to 1080 pixels by 720 pixels, and then can add the pre-processing engine 270 can process the input image 205 using image padding 220 to add 200 pixels of padding to extend the side of the input image 205 from 1080 pixels to 1280 pixels to generate an intermediate image having a resolution of 1280 pixels by 720 pixels, which matches the input resolution of the second trained ML model 240. Image segmentation 210 can follow image scaling 215 to produce fewer tiles. Image padding 220 can be used with image segmentation 210 if some of the tiles do not include enough image data to fill the entire tile size. In some examples, the pre-processing engine 270 can select pre-processing operations based on the selected trained ML model of the set of trained ML models 230 For instance, in some example, Tensor flow models or other AI SDK models can prefer to use image padding 220, so the selector 265 can select image padding 220 for such models. In some examples, hardware-based fixed function CNN models prefer to divide images into tiles and sequentially process the tiles, so the selector 265 can select image segmentation 210 for such models. In some examples, the selector 265 can select image scaling 215 to scale the input image 205 to match a model's input resolution.

By using the image segmentation 210, image scaling 215, and/or image padding 220 as pre-processing operations of the pre-processing engine 270, before passing the resulting intermediate image data to the selected trained ML model of the set of trained ML models 230, any potential downsides of these pre-processing operations can be minimized. In some examples, image padding 220 can waste device power by causing the selected trained ML model to processed the padding pixel. The more padding pixels are present, the more power/performance is wasted. For instance, input image is 1080×400, while CNN is 1080×1920, 60+ % device processor cycles are wasted. By being able to select a trained ML model of the set of trained ML models 230 that is close to the image resolution of the input image 205, the amount of padding pixels is reduced. In some examples, image scaling 215 leads to recognition accuracy loss, visual quality loss, and/or power/performance drop. For instance, if an input image 205 has an image resolution of 1080×800, and the selected trained ML model has an input resolution of 300×400, then scaling down the input image 205 can lead to image segment boundaries loss. This kind of scaling can lead to visual regression for image enhancement as well (e.g,, Scale down→ML Model→Scale Up). Reductant image scaling can cost device power as well. By being able to select a trained ML model of the set of trained ML models 230 that is close to the image resolution of the input image 205, the amount of image scaling 215 is reduced. In some examples, dividing the input image 205 into tiles and sequential processing can't match image segments or object reignitions or other entire image-based-trained CNN models. In some examples, dividing the input image 205 into tiles and sequential processing need to process tiles overlapping based on CNN reception field. Up to 50% additional processing cycle can be needed to cover overlapped CNN reception field on tiles. By being able to select a trained ML model of the set of trained ML models 230 that is close to the image resolution of the input image 205, the amount of image segmentation 210 (e.g., the amount of tiles) can be reduced.

In some examples, the pre-processing engine 270 can select the pre-processing operations to be performed by the pre-processing engine 270 based on what type of processing is to be performed (e.g., based on the use case). For instance, if the use case is image segmentation (e.g., semantic segmentation) or object recognition, image scaling 215 and/or image padding 220 can lose accuracy and/or lead to system power/performance drop, so use of these can be reduced to the extend possible by selecting a trained ML model of the set of trained ML models 230 that is close to the image resolution of the input image 205. If the use case is image background blurring or deblurring, pixel padding can cause a system power/performance drop, and thus can be reduced or avoided. For image super resolution, image scaling 215 of the input image 205 can lead to bad visual quality and system power/performance drop, and thus can be avoided or minimized (e.g., in favor of image padding 220 and/or image segmentation 210).

In some examples, the trained ML models of the set of trained ML models 230 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. In an illustrative example, the trained ML models of the set of trained ML models 230 include CNNs.

Within FIG. 2, a graphic representing the various trained ML model(s) in the set of trained ML models 230 illustrates a set of circles connected to another. Each of the circles can represent a node (e.g., node 616), a neuron, a perceptron, a layer, a portion thereof, or a combination thereof. The circles are arranged in columns, which can represent different layers. The leftmost column of white circles represent an input layer (e.g., input layer 610). The rightmost column of white circles represent an output layer (e.g., output layer 614). Two columns of shaded circled between the leftmost column of white circles and the rightmost column of white circles each represent hidden layers (e.g., hidden layers 612A-612N). The lines between nodes can represent weights between nodes, and can be adjusted in a given trained ML model as the trained ML model is trained and/or updated.

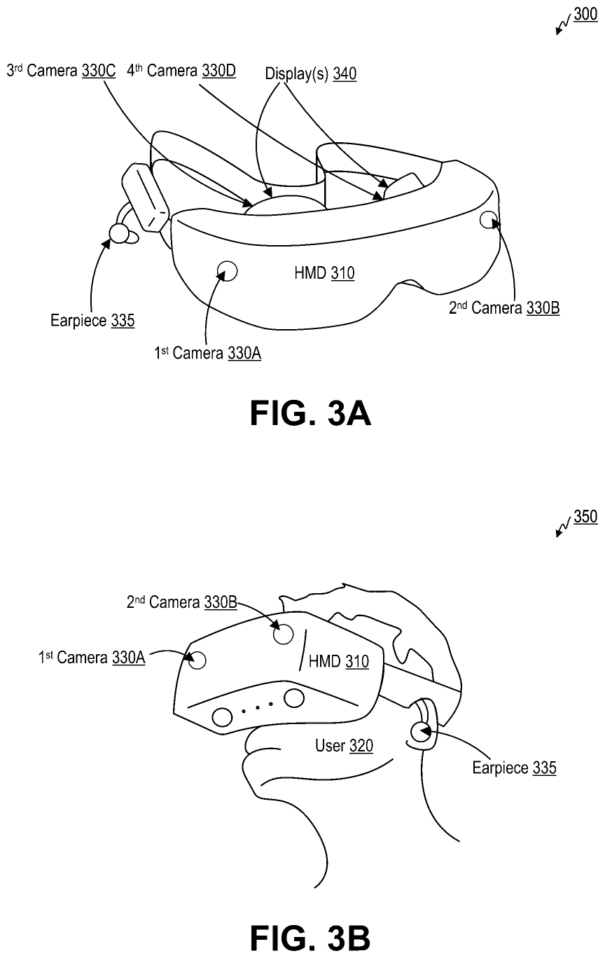

FIG. 3A is a perspective diagram 300 illustrating a head-mounted display (HMD) 310 that is used as part of an imaging system (e.g., the imaging system 200). The HMD 310 may be, for example, an augmented reality (AR) headset, a virtual reality (VR) headset, a mixed reality (MR) headset, an extended reality (XR) headset, or some combination thereof. The HMD 310 may be an example of a headset 305 and/or of an imaging system (e.g., the imaging system 200). The HMD 310 includes a first camera 330A and a second camera 330B along a front portion of the HMD 310. The first camera 330A and the second camera 330B may be examples of image sensor(s) (e.g., that capture the input image 205) of the imaging system (e.g., the imaging system 200). The HMD 310 includes a third camera 330C and a fourth camera 330D facing the eye(s) of the user as the eye(s) of the user face the display(s) 340. The third camera 330C and the fourth camera 330D may be examples of image sensor(s) (e.g., that capture the input image 205) of the imaging system (e.g., the imaging system 200). In some examples, the HMD 310 may only have a single camera with a single image sensor. In some examples, the HMD 310 may include one or more additional cameras in addition to the first camera 330A, the second camera 330B, third camera 330C, and the fourth camera 330D. In some examples, the HMD 310 may include one or more additional sensors in addition to the first camera 330A, the second camera 330B, third camera 330C, and the fourth camera 330D, which may also include other types of image sensor(s) of the imaging system (e.g., the imaging system 200). In some examples, the first camera 330A, the second camera 330B, third camera 330C, and/or the fourth camera 330D may be examples of the image capture and processing system 100, the image capture device 105A, the image processing device 105B, or a combination thereof. In some examples, any of the first camera 330A, the second camera 330B, third camera 330C, and/or the fourth camera 330D can be, or can include, depth sensors.

The HMD 310 may include one or more displays 340 that are visible to a user 320 wearing the HMD 310 on the user 320's head. The one or more displays 340 of the HMD 310 can be examples of the one or more displays of the output device(s) 835 of the computing system 800. In some examples, the HMD 310 may include one display 340 and two viewfinders. The two viewfinders can include a left viewfinder for the user 320's left eye and a right viewfinder for the user 320's right eye. The left viewfinder can be oriented so that the left eye of the user 320 sees a left side of the display. The right viewfinder can be oriented so that the right eye of the user 320 sees a right side of the display. In some examples, the HMD 310 may include two displays 340, including a left display that displays content to the user 320's left eye and a right display that displays content to a user 320's right eye. The one or more displays 340 of the HMD 310 can be digital “pass-through” displays or optical “see-through” displays.

The HMD 310 may include one or more earpieces 335, which may function as speakers and/or headphones that output audio to one or more ears of a user of the HMD 310, and may be examples of output device(s) 835 of the computing system 800. One earpiece 335 is illustrated in FIGS. 3A and 3B, but it should be understood that the HMD 310 can include two earpieces, with one earpiece for each ear (left ear and right ear) of the user. In some examples, the HMD 310 can also include one or more microphones (not pictured). The one or more microphones can be examples of the image sensor(s) (e.g., that capture the input image 205) of the imaging system (e.g., the imaging system 200). In some examples, the audio output by the HMD 310 to the user through the one or more earpieces 335 may include, or be based on, audio recorded using the one or more microphones.

FIG. 3B is a perspective diagram 350 illustrating the head-mounted display (HMD) of FIG. 3A being worn by a user 320. The user 320 wears the HMD 310 on the user 320's head over the user 320's eyes. The HMD 310 can capture images with the first camera 330A and the second camera 330B. In some examples, the HMD 310 displays one or more output images toward the user 320's eyes using the display(s) 340. In some examples, the output images can include image(s) processed by the headset 305 and/or the host device 310 according to any of the image processing schemes 300-600. The output images can be based on the images captured by the first camera 330A and the second camera 330B (e.g., as captured by the image sensor that captures the input image 205), for example processed versions and/or with the virtual content (e.g., the processed image data 260) overlaid. The output images may provide a stereoscopic view of the environment, in some cases with the virtual content overlaid and/or with other modifications. For example, the HMD 310 can display a first display image to the user 320's right eye, the first display image based on an image captured by the first camera 330A. The HMD 310 can display a second display image to the user 320's left eye, the second display image based on an image captured by the second camera 330B. For instance, the HMD 310 may provide overlaid virtual content in the display images overlaid over the images captured by the first camera 330A and the second camera 330B. The third camera 330C and the fourth camera 330D can capture images of the eyes of the before, during, and/or after the user views the display images displayed by the display(s) 340. This way, the sensor data from the third camera 330C and/or the fourth camera 330D can capture reactions to the virtual content by the user's eyes (and/or other portions of the user). An earpiece 335 of the HMD 310 is illustrated in an ear of the user 320. The HMD 310 may be outputting audio to the user 320 through the earpiece 335 and/or through another earpiece (not pictured) of the HMD 310 that is in the other ear (not pictured) of the user 320.

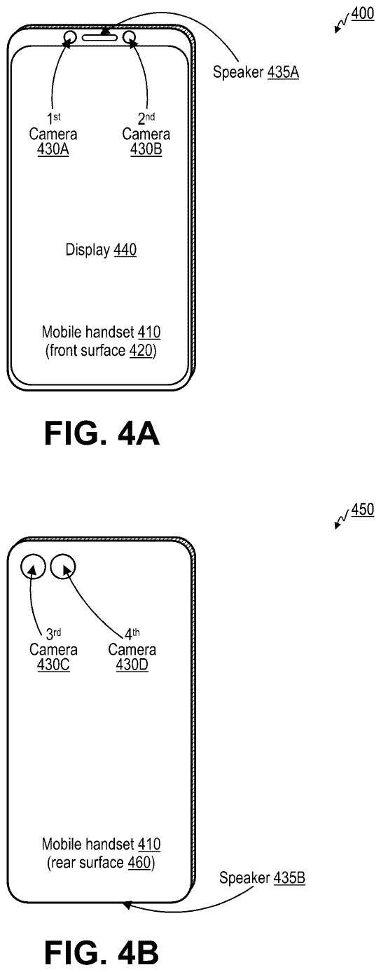

FIG. 4A is a perspective diagram 400 illustrating a front surface of a mobile handset 410 that includes front-facing cameras and can be used as part of an imaging system (e.g., imaging system (e.g., the imaging system 200)). The mobile handset 410 may be an example of a headset 305 and/or a host device 310. The mobile handset 410 may be an example of an imaging system (e.g., the imaging system 200). The mobile handset 410 may be, for example, a cellular telephone, a satellite phone, a portable gaming console, a music player, a health tracking device, a wearable device, a wireless communication device, a laptop, a mobile device, any other type of computing device or computing system discussed herein, or a combination thereof.

The front surface 420 of the mobile handset 410 includes a display 440. The front surface 420 of the mobile handset 410 includes a first camera 430A and a second camera 430B. The first camera 430A and the second camera 430B may be examples of the image sensor(s) (e.g., that capture the input image 205) of the imaging system (e.g., the imaging system 200). The first camera 430A and the second camera 430B can face the user, including the eye(s) of the user, while content (e.g., the processed image data 260) is displayed on the display 440. The display 440 may be an example of the display(s) of the output device(s) 835 of the computing system 800.

The first camera 430A and the second camera 430B are illustrated in a bezel around the display 440 on the front surface 420 of the mobile handset 410. In some examples, the first camera 430A and the second camera 430B can be positioned in a notch or cutout that is cut out from the display 440 on the front surface 420 of the mobile handset 410. In some examples, the first camera 430A and the second camera 430B can be under-display cameras that are positioned between the display 440 and the rest of the mobile handset 410, so that light passes through a portion of the display 440 before reaching the first camera 430A and the second camera 430B. The first camera 430A and the second camera 430B of the perspective diagram 400 are front-facing cameras. The first camera 430A and the second camera 430B face a direction perpendicular to a planar surface of the front surface 420 of the mobile handset 410. The first camera 430A and the second camera 430B may be two of the one or more cameras of the mobile handset 410. In some examples, the front surface 420 of the mobile handset 410 may only have a single camera.

In some examples, the display 440 of the mobile handset 410 displays one or more output images toward the user using the mobile handset 410. In some examples, the output images can include image(s) processed by the headset 305 and/or the host device 310 according to any of the image processing schemes 300-600. The output images can be based on the images (e.g., as captured by the image sensor that captures the input image 205) captured by the first camera 430A, the second camera 430B, the third camera 430C, and/or the fourth camera 430D, for example processed versions and/or with the virtual content (e.g., the processed image data 260) overlaid.

In some examples, the front surface 420 of the mobile handset 410 may include one or more additional cameras in addition to the first camera 430A and the second camera 430B. The one or more additional cameras may also be examples of the image sensor(s) (e.g., that capture the input image 205) of the imaging system (e.g., the imaging system 200). In some examples, the front surface 420 of the mobile handset 410 may include one or more additional sensors in addition to the first camera 430A and the second camera 430B. The one or more additional sensors may also be examples of the image sensor(s) (e.g., that capture the input image 205) of the imaging system (e.g., the imaging system 200). In some cases, the front surface 420 of the mobile handset 410 includes more than one display 440. The one or more displays 440 of the front surface 420 of the mobile handset 410 can be examples of the display(s) of the output device(s) 835 of the computing system 800. For example, the one or more displays 440 can include one or more touchscreen displays.

The mobile handset 410 may include one or more speakers 435A and/or other audio output devices (e.g., earphones or headphones or connectors thereto), which can output audio to one or more ears of a user of the mobile handset 410. One speaker 435A is illustrated in FIG. 4A, but it should be understood that the mobile handset 410 can include more than one speaker and/or other audio device. In some examples, the mobile handset 410 can also include one or more microphones (not pictured). The one or more microphones can be examples of the image sensor(s) (e.g., that capture the input image 205) of the imaging system (e.g., the imaging system 200). In some examples, the mobile handset 410 can include one or more microphones along and/or adjacent to the front surface 420 of the mobile handset 410, with these microphones being examples of the image sensor(s) (e.g., that capture the input image 205) of the imaging system (e.g., the imaging system 200). In some examples, the audio output by the mobile handset 410 to the user through the one or more speakers 435A and/or other audio output devices may include, or be based on, audio recorded using the one or more microphones.

FIG. 4B is a perspective diagram 450 illustrating a rear surface 460 of a mobile handset that includes rear-facing cameras and that can be used as part of an imaging system (e.g., imaging system (e.g., the imaging system 200). The mobile handset 410 includes a third camera 430C and a fourth camera 430D on the rear surface 460 of the mobile handset 410. The third camera 430C and the fourth camera 430D of the perspective diagram 450 are rear-facing. The third camera 430C and the fourth camera 430D may be examples of the image sensor(s) (e.g., that capture the input image 205) of the imaging system (e.g., the imaging system 200) of FIGS. 2, 3, and/or 4. The third camera 430C and the fourth camera 430D face a direction perpendicular to a planar surface of the rear surface 460 of the mobile handset 410.

The third camera 430C and the fourth camera 430D may be two of the one or more cameras of the mobile handset 410. In some examples, the rear surface 460 of the mobile handset 410 may only have a single camera. In some examples, the rear surface 460 of the mobile handset 410 may include one or more additional cameras in addition to the third camera 430C and the fourth camera 430D. The one or more additional cameras may also be examples of the image sensor(s) (e.g., that capture the input image 205) of the imaging system (e.g., the imaging system 200). In some examples, the rear surface 460 of the mobile handset 410 may include one or more additional sensors in addition to the third camera 430C and the fourth camera 430D. The one or more additional sensors may also be examples of the image sensor(s) (e.g., that capture the input image 205) of the imaging system (e.g., the imaging system 200). In some examples, the first camera 430A, the second camera 430B, third camera 430C, and/or the fourth camera 430D may be examples of the image capture and processing system 100, the image capture device 105A, the image processing device 105B, or a combination thereof. In some examples, any of the first camera 430A, the second camera 430B, third camera 430C, and/or the fourth camera 430D can be, or can include, depth sensors.

The mobile handset 410 may include one or more speakers 435B and/or other audio output devices (e.g., earphones or headphones or connectors thereto), which can output audio to one or more ears of a user of the mobile handset 410. One speaker 435B is illustrated in FIG. 4B, but it should be understood that the mobile handset 410 can include more than one speaker and/or other audio device. In some examples, the mobile handset 410 can also include one or more microphones (not pictured). The one or more microphones can be examples of the image sensor(s) (e.g., that capture the input image 205) of the imaging system (e.g., the imaging system 200). In some examples, the mobile handset 410 can include one or more microphones along and/or adjacent to the rear surface 460 of the mobile handset 410, with these microphones being examples of the image sensor(s) (e.g., that capture the input image 205) of the imaging system (e.g., the imaging system 200). In some examples, the audio output by the mobile handset 410 to the user through the one or more speakers 435B and/or other audio output devices may include, or be based on, audio recorded using the one or more microphones.

The mobile handset 410 may use the display 440 on the front surface 420 as a pass-through display. For instance, the display 440 may display output images, such as as processed by the headset 305 and/or the host device 310 according to any of the image processing schemes 300-600. The output images can be based on the images captured by the third camera 430C and/or the fourth camera 430D, for example processed versions and/or with the virtual content (e.g., the processed image data 260) overlaid. The first camera 430A and/or the second camera 430B can capture images of the user's eyes (and/or other portions of the user) before, during, and/or after the display of the output images with the virtual content on the display 440. This way, the sensor data from the first camera 430A and/or the second camera 430B can capture reactions to the virtual content by the user's eyes (and/or other portions of the user).

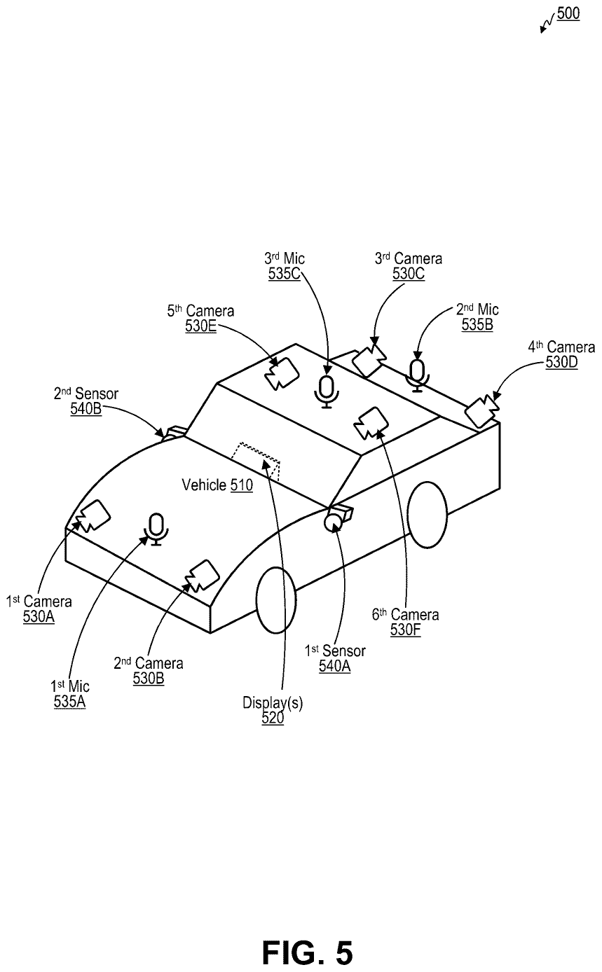

FIG. 5 is a perspective diagram 500 illustrating a vehicle 510 that includes various sensors. The vehicle 510 may be an example of one or more imaging system (e.g., the imaging system 200). The vehicle 510 may be an example of a headset 305 and/or a host device 310. The vehicle 510 is illustrated as an automobile, but may be, for example, an automobile, a truck, a bus, a train, a ground-based vehicle, an airplane, a helicopter, an aircraft, an aerial vehicle, a boat, a submarine, a watercraft, an underwater vehicle, a hovercraft, a robot, a vacuum cleaner, another type of vehicle discussed herein, or a combination thereof. In some examples, the vehicle may be at least partially controlled and/or used with sub-systems of the vehicle 510, such as ADAS of the vehicle 510, IVI systems of the vehicle 510, control systems of the vehicle 510, a vehicle electronic control unit (ECU) of the vehicle 510, or a combination thereof.

The vehicle 510 includes a display 520. The vehicle 510 includes various sensors, all of which can be examples of the image sensor(s) (e.g., that capture the input image 205). The vehicle 510 includes a first camera 530A and a second camera 530B at the front, a third camera 530C and a fourth camera 530D at the rear, and a fifth camera 530E and a sixth camera 530F on the top. The vehicle 510 includes a first microphone 535A at the front, a second microphone 535B at the rear, and a third microphone 535C at the top. The vehicle 510 includes a first sensor 540A on one side (e.g., adjacent to one rear-view mirror) and a second sensor 540B on another side (e.g., adjacent to another rear-view mirror). The first sensor 540A and the second sensor 540B may include cameras, microphones, depth sensors (e.g., Radio Detection and Ranging (RADAR) sensors, Light Detection and Ranging (LIDAR) sensors, Sound Detection and Ranging (SODAR) sensors, Sound Navigation and Ranging (SONAR) sensors, time of flight (ToF) sensors, structured light sensors, stereoscopic cameras, etc.), or any other types of sensors(s) described herein. In some examples, the vehicle 510 may include additional image sensor(s) in addition to the sensors illustrated in FIG. 5. In some examples, the vehicle 510 may be missing some of the sensors that are illustrated in FIG. 5.

In some examples, the display 520 of the vehicle 510 displays one or more output images toward a user of the vehicle 510 (e.g., a driver and/or one or more passengers of the vehicle 510). In some examples, the output images can include image(s) processed by the headset 305 and/or the host device 310 according to any of the image processing schemes 300-600. The output images can be based on the images (e.g., as captured by the image sensor that captures the input image 205) captured by the first camera 530A, the second camera 530B, the third camera 530C, the fourth camera 530D, the fifth camera 530E, the sixth camera 530F, the first sensor 540A, and/or the second sensor 540B, for example processed versions and/or with the virtual content (e.g., the processed image data 260) overlaid. In some examples, any of the first camera 530A, the second camera 530B, the third camera 530C, the fourth camera 530D, the fifth camera 530E, the sixth camera 530F, the first sensor 540A, and/or the second sensor 540B can be, or can include, depth sensors.

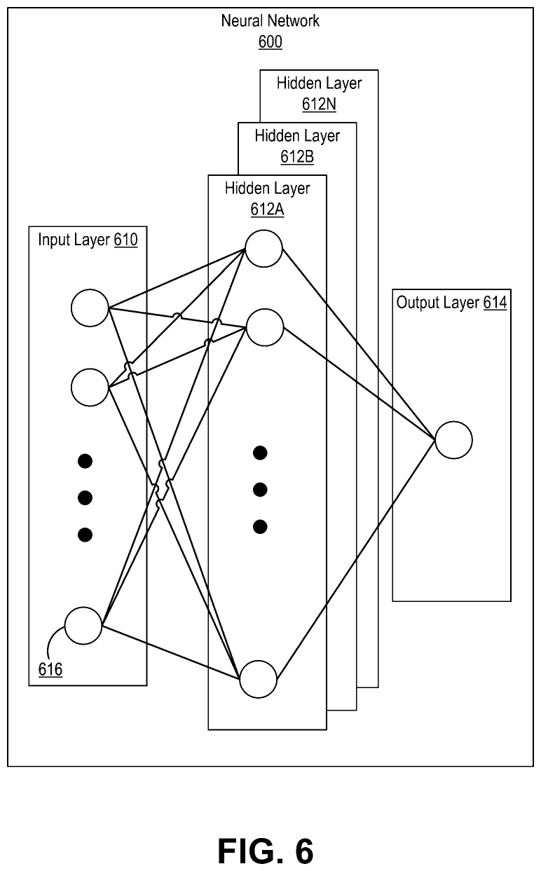

FIG. 6 is a block diagram illustrating an example of a neural network (NN) 600 that can be used for imaging operations. The neural network 600 can include any type of deep network, such as a convolutional neural network (CNN), an autoencoder, a deep belief net (DBN), a Recurrent Neural Network (RNN), a Generative Adversarial Networks (GAN), and/or other type of neural network. The neural network 600 may used for certain image processing operations by the imaging system 200. The neural network 600 can be an example of at least one of the trained ML model(s) of the set of trained ML models 230.

An input layer 610 of the neural network 600 includes input data. The input data of the input layer 610 can include data representing the pixels of one or more input image frames. In some examples, the input data of the input layer 610 includes data representing the pixels of image data (e.g., the input image 205, image(s) captured by one of the cameras 330A-330D, image(s) captured by one of the cameras 430A-430D, image(s) captured by one of the cameras 530A-530F, the image data of operation 705, image(s) captured using the input device 845, or a combination thereof). In some examples, the input data of the input layer 610 includes processed data that is to be processed further, such as intermediate image data processed using the pre-processing engine 270.

The images can include image data from an image sensor including raw pixel data (including a single color per pixel based, for example, on a Bayer filter) or processed pixel values (e.g., RGB pixels of an RGB image). The neural network 600 includes multiple hidden layers 612, 612B, through 612N. The hidden layers 612, 612B, through 612N include “N” number of hidden layers, where “N” is an integer greater than or equal to one. The number of hidden layers can be made to include as many layers as needed for the given application. The neural network 600 further includes an output layer 614 that provides an output resulting from the processing performed by the hidden layers 612, 612B, through 612N.

In some examples, the output layer 614 can provide output data, such as processed image data 260. In some examples, the processed image data 260 can include image data and/or video data that has been processed using stabilization, temporal denoising, spatial denoising, super-resolution, filtering, machine learning based denoising, machine learning based sharpening, color changes, contrast changes, saturation changes, tone mapping, white balance changes, black balance changes, any other image processing operations discussed herein, or a combination thereof.

The neural network 600 is a multi-layer neural network of interconnected filters. Each filter can be trained to learn a feature representative of the input data. Information associated with the filters is shared among the different layers and each layer retains information as information is processed. In some cases, the neural network 600 can include a feed-forward network, in which case there are no feedback connections where outputs of the network are fed back into itself. In some cases, the network 600 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 610 can activate a set of nodes in the first hidden layer 612A. For example, as shown, each of the input nodes of the input layer 610 can be connected to each of the nodes of the first hidden layer 612A. The nodes of a hidden layer can transform the information of each input node by applying activation functions (e.g., filters) to this information. The information derived from the transformation can then be passed to and can activate the nodes of the next hidden layer 612B, which can perform their own designated functions. Example functions include convolutional functions, downscaling, upscaling, data transformation, and/or any other suitable functions. The output of the hidden layer 612B can then activate nodes of the next hidden layer, and so on. The output of the last hidden layer 612N can activate one or more nodes of the output layer 614, which provides a processed output image. In some cases, while nodes (e.g., node 616) in the neural network 600 are shown as having multiple output lines, a node has a single output and all lines shown as being output from a node represent the same output value.

In some cases, each node or interconnection between nodes can have a weight that is a set of parameters derived from the training of the neural network 600. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 610 using the different hidden layers 612, 612B, through 612N in order to provide the output through the output layer 614.

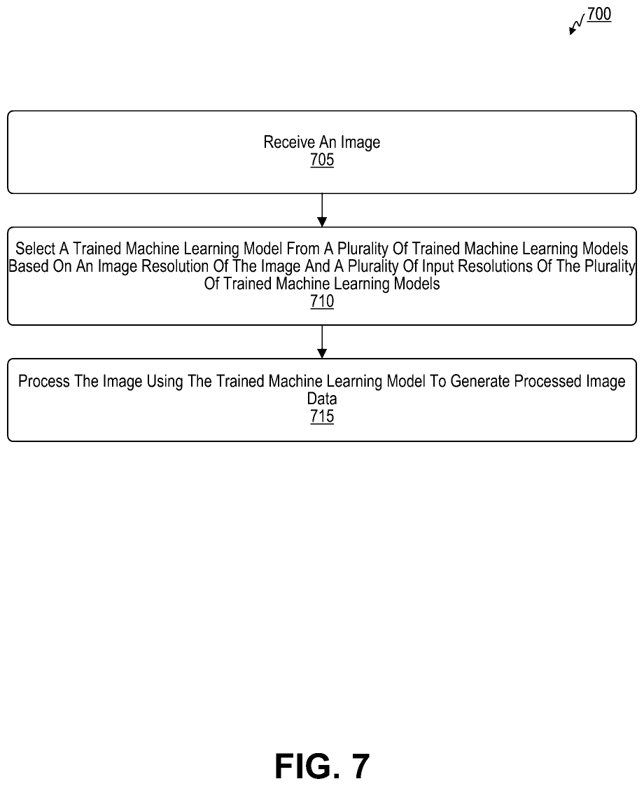

FIG. 7 is a flow diagram illustrating a process 700 for imaging. The process 700 for imaging may be performed by an imaging system (e.g., a chipset, a processor or multiple processors such as an ISP, host processor, application processor, or other processor, or other component). In some examples, the imaging system can include, for example, the image capture and processing system 100, the image capture device 105A, the image processing device 105B, the image processor 150, the ISP 154, the host processor 152, the imaging system 200, at least one of the set of trained ML models 230, the selector 265, the pre-processing engine 270, the headset 305, the host device 310, the image sensor 325, the HMD 310, the mobile handset 410, the vehicle 510, the neural network 600, the computing system 800, the processor 810, a system, and apparatus, a device, a non-transitory computer readable medium having stored thereon a program to be performed using a processor, or a combination thereof. In some examples, the imaging system includes a display. In some examples, the imaging system includes a transceiver and/or other communication interface(s).

At operation 705, the imaging system (or component thereof) is configured to, and can, receive an image.

Illustrative examples of the image of operation 705 can include, for instance, input image 205, image(s) captured by one of the cameras 330A-330D, image(s) captured by one of the cameras 430A-430D, image(s) captured by one of the cameras 530A-530F, an image used as input data for the input layer 610 of the NN 600, image(s) captured using the input device 845, or a combination thereof. In some examples, the image is captured using an image sensor. In some examples, the image sensor includes the image sensor 130, an image sensor that captures the input image 205, the first camera 330A, the second camera 330B, the third camera 330C, the fourth camera 330D, the first camera 430A, the second camera 430B, the third camera 430C, the fourth camera 430D, the first camera 530A, the second camera 530B, the third camera 530C, the fourth camera 530D, the fifth camera 530E, the sixth camera 530F, the first sensor 540A, the second sensor 540B, an image sensor used to capture an image used as input data for the input layer 610 of the NN 600, the input device 845, another image sensor described herein, another sensor described herein, or a combination thereof.

In some aspects, receiving the image (as in operation 705) includes scaling a secondary image (e.g., using image scaling 215) to generate the image. In this example, in relation to FIG. 2, the secondary image would be an example of the input image 205, and the image of operation 705 would be an example of an intermediate image pre-processed using the pre-processing engine 270. The secondary image has a secondary image resolution that is different from the image resolution of the image. In some aspects, the image resolution is closer to an input resolution of the trained machine learning model than the secondary image resolution (e.g., the image scaling 215 being used to scale the image resolution to be closer to the input resolution of one of the trained machine learning models).

In some aspects, receiving the image (as in operation 705) includes adding padding pixels (e.g., using image padding 220) to at least one side of a secondary image to generate the image. In this example, in relation to FIG. 2, the secondary image would be an example of the input image 205, and the image of operation 705 would be an example of an intermediate image pre-processed using the pre-processing engine 270. The secondary image has a secondary image resolution that is smaller than the image resolution of the image. In some aspects, the image resolution is closer to an input resolution of the trained machine learning model than the secondary image resolution (e.g., the image padding 220 being used to scale the image resolution to be closer to the input resolution of one of the trained machine learning models).

At operation 710, the imaging system (or component thereof) is configured to, and can, select a trained machine learning model from a plurality of trained machine learning models based on an image resolution of the image and a plurality of input resolutions of the plurality of trained machine learning models. Examples of the trained machine learning model and/or the plurality of trained machine learning models include the set of trained ML models 230, the first trained ML model 235, the second trained ML model 240, the third trained ML model 245, the fourth trained ML model 250, the fifth trained ML model 255, and/or the NN 600. In some examples, the selection of operation 710 is made using the selector 265.

In some aspects, selecting the trained machine learning model (as in operation 710) includes selecting, from the plurality of input resolutions (associated with the plurality of trained machine learning models), an input resolution (associated with the selected trained machine learning model) that most closely matches the image resolution (of the image received in operation 710). In some examples, the image is modified using pre-processing by the pre-processing engine 270 (e.g., using image segmentation 210, image scaling 215 and/or image padding 220) before being processed in operation 715.

In some aspects, selecting the trained machine learning model (as in operation 710) includes selecting, from the plurality of input resolutions (associated with the plurality of trained machine learning models), an input resolution (associated with the selected trained machine learning model) that is closest to the image resolution (of the image received in operation 710) while being larger than the image resolution. In some examples, the image is modified using image segmentation 210 to divide the image into tiles before being processed in operation 715. In some examples, the image is modified using image scaling 215 to downscale the image before being processed in operation 715. In some examples, the image is modified using pre-processing by the pre-processing engine 270 (e.g., using image segmentation 210, image scaling 215 and/or image padding 220) before being processed in operation 715.

In some aspects, selecting the trained machine learning model (as in operation 710) includes selecting, from the plurality of input resolutions (associated with the plurality of trained machine learning models), an input resolution (associated with the selected trained machine learning model) that is closest to the image resolution (of the image received in operation 710) while being smaller than the image resolution. In some examples, the image is modified using image padding 220 to add padding pixels before being processed in operation 715. In some examples, the image is modified using pre-processing by the pre-processing engine 270 (e.g., using image scaling 215 and/or image padding 220) before being processed in operation 715.

In some aspects, selecting the trained machine learning model (as in operation 710) includes selecting, from a plurality of estimated processing times corresponding to the plurality of trained machine learning models, at least one estimated processing time (associated with te selected trained machine learning model) that fits within a time limit. The plurality of estimated processing times indicate how long the plurality of trained machine learning models are estimated to take to process image data (in operation 715). In some aspects, selecting the trained machine learning model (as in operation 710) also includes selecting, from the plurality of input resolutions, an input resolution that is a highest resolution and that also corresponds to a first estimated processing time of the at least one estimated processing time that fits within the time limit. The input resolution is associated with the trained machine learning model, and the trained machine learning model is estimated to use the first estimated processing time to process the image. Phrased another way, in some examples, the trained machine learning model that is selected in operation 710 is the trained machine learning model with the highest input resolution for which the corresponding estimated processing time still fits within the time limit. In some aspects, the time limit is associated with a frame rate of a video, and the image is a video frame of the video. For instance, if the frame rate is N frames per second (FPS), then the time limit can be 1/N seconds. In an illustrative example, if the frame rate is 30 frames per second (FPS), then the time limit can be 1/30 of a second (or 0.0333 seconds).

At operation 715, the imaging system (or component thereof) is configured to, and can, process the image using the trained machine learning model to generate processed image data (e.g., processed image data 260).

In some aspects, the imaging system (or component thereof) is configured to, and can, segment a secondary image into a plurality of tiles (e.g., prior to operation 705). The image (that is received in operation 705) is a tile of the plurality of tiles. In some aspects, the processed image data (of operation 715) includes a processed variant of the tile. In some aspects, the imaging system (or component thereof) is configured to, and can, combine the processed variant of the tile with at least one processed variant of at least one additional tile of the plurality of tiles to generate a processed variant of the secondary image.

In some aspects, processing the image (as in operation 715) includes performing super-resolution on the image using the trained machine learning model (selected in operation 710) to generate the processed image data. The processed image data has a higher resolution than the image resolution of the image (and/or is larger than the image) (e.g., based on the super-resolution).

In some aspects, processing the image (as in operation 715) includes detecting an object in the image using the trained machine learning model to generate the processed image data. The processed image data indicates a position of the object within the image (e.g., using a bounding box as illustrated in FIG. 2).

In some aspects, processing the image (as in operation 715) includes segmenting the image into pixels (e.g. using semantic segmentation, classification, and/or image segmentation) belonging to different object categories using the trained machine learning model to generate the processed image data. The processed image data indicates which pixels of the image belong to which of the different object categories (e.g., of a plurality of possible object categories) (e.g., identifying which pixels depict skin, which pixels depict hair, which pixels depict sky, which pixels depict plants, which pixels depict stone, which pixels depict metal, which pixels depict wood, which pixels depict food, which pixels depict vehicles, which pixels depict animals, which pixels depict other materials or object types, etc.).

In some aspects, the imaging system (or component thereof) is configured to, and can, output the processed image data, for instance using an output device 835. In some examples, the imaging system includes an output device 835. In some aspects, the imaging system (or component thereof) is configured to, and can, display the processed image data using a display. In some aspects, the imaging system includes a display. In some aspects, the imaging system (or component thereof) is configured to, and can, transmit the processed image data to a recipient device using a communication interface 840. In some aspects, the imaging system includes a communication interface 840.

In some aspects, the trained machine learning model is a convolutional neural network (CNN).

In some examples, the imaging system can include means for receiving an image, such as the image sensor 130, an image sensor that captures the input image 205, the first camera 330A, the second camera 330B, the third camera 330C, the fourth camera 330D, the first camera 430A, the second camera 430B, the third camera 430C, the fourth camera 430D, the first camera 530A, the second camera 530B, the third camera 530C, the fourth camera 530D, the fifth camera 530E, the sixth camera 530F, the first sensor 540A, the second sensor 540B, an image sensor used to capture an image used as input data for the input layer 610 of the NN 600, the input device 845, another image sensor described herein, another sensor described herein, or a combination thereof. In some examples, the imaging system can include means for selecting a trained machine learning model from a plurality of trained machine learning models based on an image resolution of the image and a plurality of input resolutions of the plurality of trained machine learning models, such as the image processor 150, the host processor 152, the ISP 154, the selector 265, the neural network 600, the computing system 800, the processor 810, or a combination thereof. In some examples, the imaging system can include a means for processing the image using the trained machine learning model to generate processed image data, such as the image processor 150, the host processor 152, the ISP 154, the set of trained ML models 230, the first trained ML model 235, the second trained ML model 240, the third trained ML model 245, the fourth trained ML model 250, the fifth trained ML model 255, the neural network 600, the computing system 800, the processor 810, or a combination thereof.

In some examples, the processes described herein (e.g., the process of FIG. 1, the process of FIG. 2, the process of FIG. 6, the process 700 of FIG. 7, and/or other processes described herein) may be performed by a computing device or apparatus. In some examples, the processes described herein can be performed by the image capture and processing system 100, the image capture device 105A, the image processing device 105B, the image processor 150, the ISP 154, the host processor 152, the imaging system 200, at least one of the set of trained ML models 230, the selector 265, the pre-processing engine 270, the headset 305, the host device 310, the image sensor 325, the HMD 310, the mobile handset 410, the vehicle 510, the neural network 600, the computing system 800, the processor 810, or a combination thereof.

The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, a vehicle or computing device of a vehicle, a robotic device, a television, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes described herein are illustrated as logical flow diagrams, block diagrams, or conceptual diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

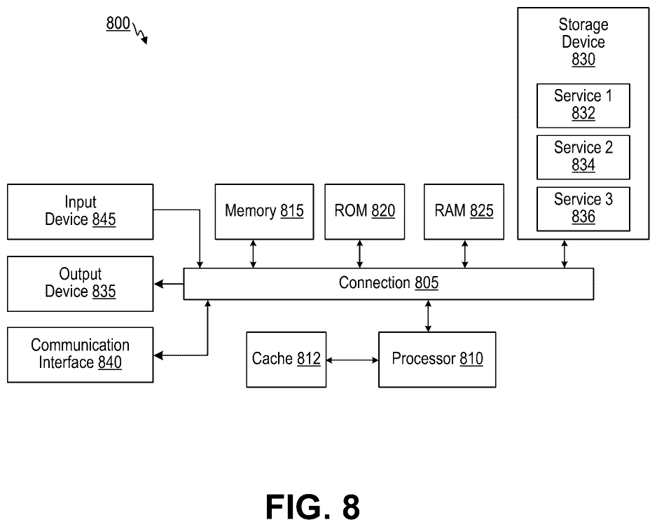

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:

Aspect 1. An apparatus for imaging, the apparatus comprising: a memory; and at least one processor (e.g., implemented in circuitry) coupled to the memory and configured to: receive an image; select a trained machine learning model from a plurality of trained machine learning models based on an image resolution of the image and a plurality of input resolutions of the plurality of trained machine learning models; and process the image using the trained machine learning model to generate processed image data.

Aspect 2. The apparatus of Aspect 1, the at least one processor configured to: select, from the plurality of input resolutions, an input resolution that most closely matches the image resolution to select the trained machine learning model, wherein the input resolution is associated with the trained machine learning model.

Aspect 3. The apparatus of any of Aspects 1 to 2, the at least one processor configured to: select, from the plurality of input resolutions, an input resolution that is closest to the image resolution while being larger than the image resolution to select the trained machine learning model, wherein the input resolution is associated with the trained machine learning model.

Aspect 4. The apparatus of any of Aspects 1 to 3, the at least one processor configured to: select, from a plurality of estimated processing times corresponding to the plurality of trained machine learning models, at least one estimated processing time that fits within a time limit, wherein the plurality of estimated processing times indicate how long the plurality of trained machine learning models are estimated to take to process image data; and select, from the plurality of input resolutions, an input resolution that is a highest resolution and that also corresponds to a first estimated processing time of the at least one estimated processing time that fits within the time limit to select the trained machine learning model, wherein the input resolution is associated with the trained machine learning model, and wherein the trained machine learning model is estimated to use the first estimated processing time to process the image.

Aspect 5. The apparatus of Aspect 4, wherein the time limit is associated with a frame rate of a video, wherein the image is a video frame of the video.

Aspect 6. The apparatus of any of Aspects 1 to 5, the at least one processor configured to: segment a secondary image into a plurality of tiles, wherein the image is a tile of the plurality of tiles, and wherein the processed image data includes a processed variant of the tile.

Aspect 7. The apparatus of Aspect 6, the at least one processor configured to: combine the processed variant of the tile with at least one processed variant of at least one additional tile of the plurality of tiles to generate a processed variant of the secondary image.

Aspect 8. The apparatus of any of Aspects 1 to 7, the at least one processor configured to: scale a secondary image to receive the image, wherein the secondary image has a secondary image resolution that is different from the image resolution of the image.

Aspect 9. The apparatus of Aspect 8, wherein the image resolution is closer to an input resolution of the trained machine learning model than the secondary image resolution.

Aspect 10. The apparatus of any of Aspects 1 to 9, the at least one processor configured to: add padding pixels to at least one side of a secondary image to receive the image, wherein the secondary image has a secondary image resolution that is smaller than the image resolution of the image.

Aspect 11. The apparatus of Aspect 10, wherein the image resolution is closer to an input resolution of the trained machine learning model than the secondary image resolution.

Aspect 12. The apparatus of any of Aspects 1 to 11, the at least one processor configured to: perform super-resolution on the image using the trained machine learning model to process the image to generate the processed image data, wherein the processed image data has a higher resolution than the image resolution of the image.

Aspect 13. The apparatus of any of Aspects 1 to 12, the at least one processor configured to: detect an object in the image using the trained machine learning model to process the image to generate the processed image data, wherein the processed image data indicates a position of the object within the image.

Aspect 14. The apparatus of any of Aspects 1 to 13, the at least one processor configured to: segment the image into pixels belonging to different object categories using the trained machine learning model to process the image to generate the processed image data, wherein the processed image data indicates which pixels of the image belong to which of the different object categories.

Aspect 15. The apparatus of any of Aspects 1 to 14, the at least one processor configured to: output the processed image data.

Aspect 16. The apparatus of any of Aspects 1 to 15, further comprising: a display configured to display the processed image data.

Aspect 17. The apparatus of any of Aspects 1 to 16, further comprising: a communication interface configured to transmit the processed image data to a recipient device.

Aspect 18. The apparatus of any of Aspects 1 to 17, wherein the apparatus includes at least one of a head-mounted display (HMD), a mobile handset, or a wireless communication device.

Aspect 19. The apparatus of any of Aspects 1 to 18, wherein the trained machine learning model is a convolutional neural network (CNN).

Aspect 20. A method for image processing, the method comprising: receiving an image; selecting a trained machine learning model from a plurality of trained machine learning models based on an image resolution of the image and a plurality of input resolutions of the plurality of trained machine learning models; and processing the image using the trained machine learning model to generate processed image data.

Aspect 21. The method of Aspect 20, wherein selecting the trained machine learning model includes selecting, from the plurality of input resolutions, an input resolution that most closely matches the image resolution, wherein the input resolution is associated with the trained machine learning model.

Aspect 22. The method of any of Aspects 20 to 21, wherein selecting the trained machine learning model includes selecting, from the plurality of input resolutions, an input resolution that is closest to the image resolution while being larger than the image resolution, wherein the input resolution is associated with the trained machine learning model.

Aspect 23. The method of any of Aspects 20 to 22, wherein selecting the trained machine learning model includes: selecting, from a plurality of estimated processing times corresponding to the plurality of trained machine learning models, at least one estimated processing time that fits within a time limit, wherein the plurality of estimated processing times indicate how long the plurality of trained machine learning models are estimated to take to process image data; and selecting, from the plurality of input resolutions, an input resolution that is a highest resolution and that also corresponds to a first estimated processing time of the at least one estimated processing time that fits within the time limit, wherein the input resolution is associated with the trained machine learning model, and wherein the trained machine learning model is estimated to use the first estimated processing time to process the image.

Aspect 24. The method of any of Aspects 20 to 23, further comprising: segmenting a secondary image into a plurality of tiles, wherein the image is a tile of the plurality of tiles, and wherein the processed image data includes a processed variant of the tile.

Aspect 25. The method of any of Aspects 20 to 24, wherein receiving the image includes scaling a secondary image to generate the image, wherein the secondary image has a secondary image resolution that is different from the image resolution of the image.

Aspect 26. The method of any of Aspects 20 to 25, wherein receiving the image includes adding padding pixels to at least one side of a secondary image to generate the image, wherein the secondary image has a secondary image resolution that is smaller than the image resolution of the image.

Aspect 27. The method of any of Aspects 20 to 26, wherein processing the image includes performing super-resolution on the image using the trained machine learning model to generate the processed image data, wherein the processed image data has a higher resolution than the image resolution of the image.

Aspect 28. The method of any of Aspects 20 to 27, wherein processing the image includes detecting an object in the image using the trained machine learning model to generate the processed image data, wherein the processed image data indicates a position of the object within the image.

Aspect 29. The method of any of Aspects 20 to 28, wherein processing the image includes segmenting the image into pixels belonging to different object categories using the trained machine learning model to generate the processed image data, wherein the processed image data indicates which pixels of the image belong to which of the different object categories.

Aspect 30. The method of any of Aspects 20 to 29, further comprising: outputting the processed image data.

Aspect 31. A non-transitory computer-readable medium having stored thereon instructions that, when executed by one or more processors, cause the one or more processors to perform operations according to any of Aspects 1 to 29.

Aspect 32. An apparatus for imaging, the apparatus comprising one or more means for performing operations according to any of Aspects 1 to 29.

1. An apparatus for image processing, the apparatus comprising:
at least one memory; and
at least one processor coupled to the at least one memory and configured to:
receive an image;
select a trained machine learning model from a plurality of trained machine learning models based on an image resolution of the image and a plurality of input resolutions of the plurality of trained machine learning models; and
process the image using the trained machine learning model to generate processed image data.

2. The apparatus of claim 1, the at least one processor configured to:
select, from the plurality of input resolutions, an input resolution that most closely matches the image resolution to select the trained machine learning model, wherein the input resolution is associated with the trained machine learning model.

3. The apparatus of claim 1, the at least one processor configured to:
select, from the plurality of input resolutions, an input resolution that is closest to the image resolution while being larger than the image resolution to select the trained machine learning model, wherein the input resolution is associated with the trained machine learning model.

4. The apparatus of claim 1, the at least one processor configured to:
select, from a plurality of estimated processing times corresponding to the plurality of trained machine learning models, at least one estimated processing time that fits within a time limit, wherein the plurality of estimated processing times indicate how long the plurality of trained machine learning models are estimated to take to process image data; and
select, from the plurality of input resolutions, an input resolution that is a highest resolution and that also corresponds to a first estimated processing time of the at least one estimated processing time that fits within the time limit to select the trained machine learning model, wherein the input resolution is associated with the trained machine learning model, and wherein the trained machine learning model is estimated to use the first estimated processing time to process the image.

5. The apparatus of claim 4, wherein the time limit is associated with a frame rate of a video, wherein the image is a video frame of the video.

6. The apparatus of claim 1, the at least one processor configured to:
segment a secondary image into a plurality of tiles, wherein the image is a tile of the plurality of tiles, and wherein the processed image data includes a processed variant of the tile.

7. The apparatus of claim 6, the at least one processor configured to:
combine the processed variant of the tile with at least one processed variant of at least one additional tile of the plurality of tiles to generate a processed variant of the secondary image.

8. The apparatus of claim 1, the at least one processor configured to:
scale a secondary image to receive the image, wherein the secondary image has a secondary image resolution that is different from the image resolution of the image.

9. The apparatus of claim 8, wherein the image resolution is closer to an input resolution of the trained machine learning model than the secondary image resolution.

10. The apparatus of claim 1, the at least one processor configured to:
add padding pixels to at least one side of a secondary image to receive the image, wherein the secondary image has a secondary image resolution that is smaller than the image resolution of the image.

11. The apparatus of claim 10, wherein the image resolution is closer to an input resolution of the trained machine learning model than the secondary image resolution.

12. The apparatus of claim 1, the at least one processor configured to:
perform super-resolution on the image using the trained machine learning model to process the image to generate the processed image data, wherein the processed image data has a higher resolution than the image resolution of the image.

13. The apparatus of claim 1, the at least one processor configured to:
detect an object in the image using the trained machine learning model to process the image to generate the processed image data, wherein the processed image data indicates a position of the object within the image.

14. The apparatus of claim 1, the at least one processor configured to:
segment the image into pixels belonging to different object categories using the trained machine learning model to process the image to generate the processed image data, wherein the processed image data indicates which pixels of the image belong to which of the different object categories.

15-19. (canceled)

20. A method for image processing, the method comprising:
receiving an image;
selecting a trained machine learning model from a plurality of trained machine learning models based on an image resolution of the image and a plurality of input resolutions of the plurality of trained machine learning models; and
processing the image using the trained machine learning model to generate processed image data.

21. The method of claim 20, wherein selecting the trained machine learning model includes selecting, from the plurality of input resolutions, an input resolution that most closely matches the image resolution, wherein the input resolution is associated with the trained machine learning model.

22. The method of claim 20, wherein selecting the trained machine learning model includes selecting, from the plurality of input resolutions, an input resolution that is closest to the image resolution while being larger than the image resolution, wherein the input resolution is associated with the trained machine learning model.

23. The method of claim 20, wherein selecting the trained machine learning model includes:
selecting, from a plurality of estimated processing times corresponding to the plurality of trained machine learning models, at least one estimated processing time that fits within a time limit, wherein the plurality of estimated processing times indicate how long the plurality of trained machine learning models are estimated to take to process image data; and
selecting, from the plurality of input resolutions, an input resolution that is a highest resolution and that also corresponds to a first estimated processing time of the at least one estimated processing time that fits within the time limit, wherein the input resolution is associated with the trained machine learning model, and wherein the trained machine learning model is estimated to use the first estimated processing time to process the image.

24. The method of claim 20, further comprising:
segmenting a secondary image into a plurality of tiles, wherein the image is a tile of the plurality of tiles, and wherein the processed image data includes a processed variant of the tile.

25. The method of claim 20, wherein receiving the image includes scaling a secondary image to generate the image, wherein the secondary image has a secondary image resolution that is different from the image resolution of the image.

26-30. (canceled)
